(19) United States
(12) Patent Application Publication
(10) Pub. No.: US 2024/0017386 A1
(43) Pub. Date: Jan. 18, 2024

(54) Improved Bolt Tensioner

(71) Applicant: Acutension Limited, Wolverhampton (GB)

(72) Inventor: Philip Jarvis, Wolverhampton (GB)

(21) Appl. No.: 18/037,230

(22) PCT Filed: Nov. 16, 2021
(86) PCT No.: PCT/EP2021/081823

§ 371 Date: May 16, 2023

(30) Foreign Application Priority Data
Nov. 16, 2020 (GB) 2017991.7
Oct. 15, 2021 (GB) 2114781.4

(51) Int. Cl. B25B 29/02

(52) U.S. Cl. CPC B25B 29/02

(57) ABSTRACT

A bolt tensioner (1, 100) having a load cell (30, 130) with at least one piston (41, 141) and a piston retraction mechanism. The bolt tensioner (1, 100) has a first fluid port (33) and a second fluid port (35), each in fluid communication with the at least one piston (41, 141) for receiving a pressurised fluid to apply thereto a tensioning force and return force respectively. The piston (41, 141) can be operated in each of the tensioning and retraction directions under fluid pressure.

### FIELD OF INVENTION

This invention relates to the field of bolt tensioners for high performance bolting operations.

### BACKGROUND

Torque wrenches and bolt tensioners are two competing technologies for applications which require components to be bolted together at high loads and stresses. It is generally accepted that bolt tensioners are the preferred option for applications requiring high tensile loads within the bolt and when a higher degree of precision is required with respect to the loading applied to the bolt. When the load applied to the bolt (or the bolt tensioning tool itself) approaches the failure point (e.g. the yield stress) of the material of the bolt or tool, it is critical not to over-tension the bolt.

Conventional bolt tensioners ‘stretch’ the bolt while a nut is wound along the bolt to its tightened position. In order to provide the high forces required to tension large bolts, a hydraulic piston within the bolt tensioner is powered by a high pressure hydraulic pump, typically operating at 1500 bar (150 MPa) or greater. In order to achieve the high pressure required, hydraulic pumps for bolt tensioners have a very low flow rate. Although the technology is well-established, there are inherent risks, or at least perceived risks, to any system operating at such high pressures, especially when tensioning bolts to near the failure limits of the bolt material. Should a component fail, whether in the tool or the bolt, the result can be dangerous to the tool operators nearby, as well as potentially causing damage to the construction itself.

In comparison, hydraulic torque wrenches are conventionally powered by hydraulic pumps operating at a much lower pressure, often with a maximum operating pressure of approximately 700 bar (70 MPa). Due to the lower pressures involved, hydraulic torque wrench systems are sometimes perceived as more safe. The lower operating pressure of hydraulic torque wrenches is counteracted by pumping higher volumes of hydraulic fluid and using a ratcheting mechanism to progressively achieve the same load within a nut and bolt. Hydraulic pumps for torque wrenches are thus designed with greater flow rates than the pumps for bolt tensioners. Torque wrenches require a dual output pump which is able to cycle between its outputs to progressively drive forward rotation of the tool head (and thus the nut) and then to drive the tool in reverse to reset the tool head for the next cycle. It is well-established that pumps for bolt tensioners are thus incompatible with torque wrenches and vice versa.

The present invention attempts to resolve and/or ameliorate one or more of the problems with existing bolt tensioners and/or provide a valuable alternative.

### SUMMARY OF INVENTION

According to a first aspect of the invention, there is provided a bolt tensioner comprising a load cell comprising at least one piston and a piston retraction mechanism. The bolt tensioner may comprise a first fluid port in fluid communication with the at least one piston for receiving a pressurised fluid to apply a tensioning force thereto. The piston retraction mechanism may comprise a second fluid port operatively connected to the at least one piston for receiving a pressurised fluid to apply a return force thereto, said return force being opposite to the tensioning force.

The inventors have identified that providing two fluid ports for the bolt tensioner allows for the bolt tensioner to be connected to two fluid sources and drive the piston in two (e.g. opposite) directions. This provides a mechanism which can be operated to drive and to retract the piston e.g. under the power of a fluid pump. This allows the tool to be quickly reset after a tensioning operation e.g. prior to removal and ready for relocation of the tool whereby the process can be repeated as many times as necessary. Similarly, the tool can subsequently be operated in a stepwise manner to increase tension in the bolt in multiple steps rather than in a single tensioning step. The two fluid sources may be provided by a single, dual-output pump, such as those used for conventional torque wrenches.

The at least one piston comprises a piston head located within a piston chamber in the load cell. The bolt tensioner may further comprise a manifold configured to direct fluid from the first fluid port to the piston chamber on a first side of the piston head. The piston retraction mechanism may be configured to direct fluid from the second fluid port to the piston chamber on the opposite side of the piston head.

In one series of embodiments, the at least one piston comprises a first piston and a second piston. The manifold may be configured to connect the first fluid port to the first and second piston.

The inventors have identified that if a conventional bolt tensioner is operated at the lower pressures (e.g. approximately 700 bar) used with conventional torque wrenches, the total force exerted by the bolt tensioner would be proportionally lower. For a bolt tensioner operating at a lower pressure to apply the same total force to a bolt, the effective area of the piston must be increased proportionally. The inventors have thus identified that a dual or multiple-piston design can be combined with a lower pressure fluid source to achieve equivalent high tensions in a bolt achievable through conventional 1500 bar bolt tensioners. Advantageously, since the flow rates of lower pressure pumps are much greater, the tensioning step is carried out more quickly than a tensioning step carried out using high-pressure fluid pumps. Furthermore, the same power output is achievable at lower pressures, which thus benefits from the improved safety of reduced pressure systems.

In one series of embodiments, the load cell comprises a body comprising at least one piston chamber for the at least one piston. The load cell may comprise a first and second piston chamber for the first and second pistons respectively (e.g. the body may comprise first and second piston chambers). In such embodiments, the body may be a single component (e.g. machined from a single blank or work piece) with first and second piston chambers formed integrally therein, thus minimising failure points. The load cell may comprise a shoulder located between the first and second piston chambers. The shoulder may be integrally formed with the rest of the body. A first side of the shoulder may form a surface (e.g. an upper surface) of the first piston chamber and a second side of the shoulder may form a surface (e.g. a lower surface) of the second piston chamber. The shoulder may form a hard stop limiting the movement of the first and/or second pistons. The shoulder may limit the movement of the first and/or second pistons in the tensioning direction as well as in the retraction direction. For example, the shoulder may form a hard stop limiting the movement of the first piston in the tensioning direction, and limiting the movement of the second piston in the retraction direction (or vice versa).

In one series of embodiments, the load cell comprises a manifold integrally formed in the body. The first and second fluid ports may be formed in or connected to the body. The manifold may comprise a plurality of fluid pathways extending through the wall of the body. In one series of embodiments, the fluid pathways may be formed in the body by a drilling or milling process. The fluid pathways may be formed in the body at the same time as the first and optionally second piston chambers.

In an alternative series of embodiments, the manifold may comprise a separate component connected to a wall of the body. The load cell may comprise a body formed of a first material. The manifold may be formed of a second material. The manifold may be connected to the body by one or more mechanical fasteners. The mechanical fasteners may comprise any suitable mechanical fastener, such as bolts or machine screws.

In both series of embodiments, the first and second fluid ports may be located on the manifold. The first and second fluid ports may comprise hose connectors. The hose connectors may be connected to the manifold via cooperating screw threaded portions. The manifold may comprise one or more passageways therethrough. The one or more passageways may connect the first and second fluid ports to the piston chamber. In embodiments in which the bolt tensioner comprises a second piston, the one or more passageways may optionally further connect the first and/or second fluid ports to a second piston chamber in which the second piston is located. The passageways in the manifold may connect to passageways formed in the body. The passageways in the manifold and body may be parallel to and adjacent to the axis of the mechanical fasteners.

In embodiments comprising an integral manifold, the load cell may comprise a lightweight metal or alloy. In embodiments comprising a separate manifold, the first material may comprise a lightweight metal or alloy. The first material may be “lightweight” in the sense that it has a lower density than the second material. The lightweight metal or first material may be aluminium. Alternatively, the lightweight metal or first material may be titanium. The use of a lightweight metal is desirable since it significantly reduces the weight of the bolt tensioner.

In embodiments comprising a separate manifold, the second material may comprise a material stronger than the first material. The second material may be steel e.g. a low carbon steel. The steel may be a BS 970 steel or any comparable grade of low carbon, high tensile steel such as an ASTM A29 steel or a JIS G4103 steel. Alternatively, the second material may be a nickel-based alloy. The use of steel is desirable, since it is sufficiently strong to safely connect to the hose connectors via screw-threaded portions in high pressure hydraulic applications. Thus, these embodiments are able to safely reduce the weight of the bolt tensioner without risking screw-threaded connections into a lightweight material such as aluminium.

In one series of embodiments, the first and second pistons may be located coaxially of each other e.g. in a stacked configuration. By the term ‘coaxially’, it is intended to refer to the longitudinal axis of the pistons, the bolt tensioner, and/or the bolt to be tensioned. The axial direction may be the movement axis of the first and second pistons. By stacking the first and second pistons, the effective area of the combined pistons can be significantly increased without increasing the diameter of the at least one piston and/or footprint or width of the bolt tensioner. This is especially valuable in the wind turbine and oil and gas industries, where bolts are located very close together and space for the bolt tensioner is limited.

The bolt tensioner may comprise a piston connector connecting the first and second pistons. The piston connector may comprise a screw thread and/or interlocking formation for engaging a corresponding screw thread and/or interlocking formation on the first and/or second pistons. In some embodiments, the first piston, second piston and the piston connector may be integrally formed. In one series of embodiments, the first piston and the piston connector are integrally formed and connected to the second piston by a screw thread. The piston connector ensures that the first and second piston move simultaneously. The piston connector may comprise a tubular shaft. The shaft may be configured to receive at least part of a bolt coupling therein. The piston connector may be interchangeable e.g. the piston connector may be provided in a range of different sizes to correspond with a range of different sized bolt couplings. The shoulder may comprise a seal for sealing with and/or against the piston connector e.g. between the first and second pistons.

The piston retraction mechanism may be configured to direct fluid from the second fluid port to only one of the first and second pistons e.g. the first piston. For example, the first fluid port may be connected to the first and second piston chamber, and the second fluid port may be connected only to the first piston chamber. This configuration is particularly advantageous, because with the first and second piston connected to each other, driving one piston in the retraction direction will retract both. Since only one piston chamber is filled, the volume of fluid required to drive the pistons is reduced. For example, if the first and second piston have the same effective area, driving a single piston in the retraction direction requires approximately half the volume of fluid compared to driving both of the pistons in a tensioning direction. If the flow rate from the fluid pump is constant, the retraction is achieved in half of the time required to drive the pistons in the tensioning direction. In practice, the flow rate from the fluid pumps decreases as the pressure output increases. Since there is only low resistance to the piston movement in the retraction direction (due to needing to drive the residual fluid from the other side of the piston), high forces and thus high pressures are not needed for the piston retraction. Thus, the retraction movement can be achieved far quicker than the tensioning movement.

In one series of embodiments, the at least one piston may be a hydraulic piston. The piston retraction mechanism may be hydraulically driven. Hydraulics are preferred over pneumatics due to the high tensioning forces involved in typical bolt tensioning applications.

In one series of embodiments, the at least one piston may have a stroke length of up to (i.e. the maximum stroke length is 30 mm). Alternatively, in some embodiments, the stroke length may be greater than 30 mm. It would be understood that the desired tension in the bolt is likely to be achieved prior to the maximum stroke length of the piston being reached. By providing a piston with a stroke length of up to 30 mm (or alternatively greater than 30 mm) the desired tension in the bolt can be quickly achieved in a single tensioning step.

In some embodiments, the stroke length may be up to 25 mm, up to 20 mm, up to 15 mm, up to 12 mm, or up to 10 mm. The bolt tensioner may be provided in a range of different sizes, wherein each size of bolt tensioner has a piston with a respective stroke length. For example, a ‘small’ bolt tensioner may have a piston with a stroke length of 10 mm, a ‘medium’ bolt tensioner may have a piston with a stroke length of 20 mm, a ‘large’ bolt tensioner may have a piston with a stroke length of 30 mm, a ‘very large’ bolt tensioner may have a piston with a stroke length of greater than 30 mm. Conventional bolt tensioners typically have a piston stroke length of 15 mm or less, although some tensioners for some applications will have a greater stroke length. In some modes of operation of the present invention, the increase of tension in the bolt can be achieved by the bolt tensioner disclosed herein in a stepwise manner, and thus it does not necessitate long stroke lengths. The stroke length only needs to be sufficiently long to accommodate any elastic stretch in the bolt and then increase the tension therein. Thus, the height of the piston chamber and thus the bolt tensioner can be minimised. In this manner, a bolt tensioner in accordance with the present disclosure and this mode of operation can be smaller and/or lighter (and, consequently, more portable and more manoeuvrable when in use) than conventional bolt tensioners.

In other examples, the at least one piston may have a stroke length greater than 15 mm. Such examples may be useful in bolt tensioner applications where a large bolt extension (as opposed to a large tensioning force) is required, e.g., in applications where there is a large amount of joint compliance. For these applications, the piston may have a stoke length from 10 mm to 50 mm. Similar to the previously-discussed series of embodiments, the bolt tensioner for these applications may be provided in a range of different sizes, wherein each size of bolt tensioner has a piston with a respective stroke length. For example, a ‘small’ bolt tensioner may have a piston with a stroke length of 10 mm, a ‘medium’ bolt tensioner may have a piston with a stroke length of 15 mm, a ‘large’ bolt tensioner may have a piston with a stroke length of 30 mm, a ‘very large’ bolt tensioner may have a piston with a stroke length of 50 mm.

The bolt tensioner may further comprise a bridge configured to extend over and/or around a nut and bolt to be tensioned and seat against the surface in which said nut and bolt are located. The bridge may comprise a chamber for receiving a nut rotating socket for engaging with the nut.

The bridge may be connectable to or integrally formed with the load cell. The bridge may be connectable to the load cell by cooperating screw threads formed on the bridge and the load cell respectively. The bridge may be configured such that it forms a surface of the at least one piston. For example, the bridge may form part of a piston chamber e.g. the lower surface. The bridge may comprise a first seal for sealing to a wall of the load cell. For example, the bridge may comprise a first seal for sealing to a wall of the body. The bridge may comprise a second seal for sealing with a portion of the at least one piston. The at least one piston may comprise a piston tail portion which extends past the second seal to define part of a piston chamber for the at least one piston. The piston tail portion and second seal may be configured to allow sliding axial movement of the piston tail portion relative to the second seal. Using the bridge as a surface (e.g. lower surface) of the piston chamber is desirable, since it omits the need for the load cell to have such a lower surface. This reduces the overall height of the at least one piston and thus the bolt tensioner. Furthermore, the bridge may form a hard stop limiting the movement of the first and/or second pistons e.g. when the piston is being retracted. The bridge may form a hard stop in the retraction direction for the first piston and optionally, in combination with the shoulder forming a hard stop in the retraction direction for the second piston. This distributes the force applied during retraction such that damage to the bridge, and thus the first piston chamber, may be avoided.

In one series of embodiments, the bridge connects to the body adjacent to the first piston i.e. the first piston may be the piston adjacent the bridge and/or located between the bridge and the shoulder. The first piston may be located closest to the nut and/or bolt and/or furthest from the head of the bolt coupling.

The bolt tensioner may further comprising a nut drive mechanism configured to provide a torque to a nut in use. The nut drive mechanism may be located in or adjacent to the bridge. The nut drive mechanism may be configured to automatically rotate a nut rotating socket and/or may be configured to automatically rotate a nut directly. The nut drive mechanism may comprise a motor, such as an electric motor. Alternatively, the nut drive mechanism may be hydraulically or pneumatically driven.

The bolt tensioner may further comprise a bolt coupling for engaging a bolt to be tensioned. The bolt coupling may comprise a drive surface configured to be contacted and driven by the or a piston. The bolt coupling may comprise a screw-threaded portion for engaging a corresponding screw-thread on the bolt to be tensioned. In some embodiments, the bolt coupling may be of the split nut-type e.g. comprising two or more bolt coupling portions which are moveable relative to each other and can be closed together to lock onto a bolt located between the bolt coupling portions. In some embodiments, the bolt coupling may comprise a bolt coupling bar assembly comprising a first portion connectable to a bolt and a second portion comprising the drive surface, wherein the first and second portions are connectable via cooperating screw threads. The second portion may be a reaction nut. The second portion may comprise a safety fracture feature configured to ensure safe failure of the bolt coupling once the bolt coupling bar assembly fatigue life has expired. The bolt coupling bar assembly may enable the bolt tensioner to have a greatly reduced footprint by spreading the resultant stresses within the tool (arising from the forces generated during tensioning) axially rather than laterally.

The bolt tensioner may further comprise a bolt coupling drive mechanism configured to apply a torque to the bolt coupling in use. The bolt coupling drive mechanism may be configured to automatically rotate a bolt coupling. The bolt coupling drive mechanism may comprise a motor, such as an electric motor. Alternatively, the bolt coupling drive mechanism may be hydraulically or pneumatically driven.

In one series of embodiments, the bolt tensioner comprises a manually drivable nut rotating socket and or a manually drivable bolt coupling.

According to a second aspect of the invention, there is provided a bolt tensioner system for tensioning a bolt comprising: one or more bolt tensioners as described herein and one or more fluid pumps comprising at least two output feeds.

By using a fluid pump with at least two output feeds, it is possible to drive the piston in the tensioning and retraction directions from a single pump. The fluid pump may be a torque wrench pump. The fluid pump may be manually controllable by an operator e.g. to switch between fluid ports and thus to switch between driving the at least one piston in the tensioning and retraction directions. In some embodiments, the fluid pump may be configured to automatically pump fluid into the second fluid port once the tensioning operation is completed. E.g. the pistons may be automatically returned to their starting positions once the tensioning is completed, and thus the bolt tensioner can be demounted from the bolt and repositioned for a subsequent tensioning operation.

In some embodiments, the fluid pump may be configured to automatically cycle between each output feed. Thus, the fluid pump may drive the bolt tensioner to automatically cycle between the tensioning and retraction directions. Thus, the bolt tensioner system operator need not control the pump, and can instead tighten the nut and/or bolt coupling as needed to progressively increase the tension in the bolt until the target tension is achieved.

In one series of embodiments, the fluid pump may have a maximum output pressure of 1000 bar. Optionally, the fluid pump may have a maximum output pressure of 900, 850, 800, 750 or 700 bar. In one embodiment, the fluid pump has a maximum output pressure of 700 to 800 bar (70-80 MPa).

In an alternative series of embodiments, the fluid pump may have a maximum output pressure of 800 to 1600 bar. For example, the fluid pump may have a maximum output of between 1200 and 1600 bar, or between 1300 and 1500 bar.

In yet another alternative series of embodiments, the fluid pump may have a maximum output pressure in excess of 1600 bar.

According to a third aspect of the invention, there is provided a method for tensioning a bolt. The method may comprise engaging a nut with a bolt. The method may comprise connecting a bolt tensioner as described herein to the bolt. The method may comprise performing a tensioning operation comprising: operating the bolt tensioner to increase the tension in the bolt by less than a target tension, tightening the nut, and retracting the piston. The method may comprise repeating the tensioning operation until the target tension is achieved

The method is particularly advantageous, since it breaks the tensioning process into multiple discrete steps. When tensioning a bolt, the bolt tensioner must first overcome any elastic stretch within the bolt assembly e.g. due to compliance within the joint surfaces and due to the bolt thread stretching. If this is not achieved, once the tensioning force is removed, the bolt assembly relaxes and reduces the tension therein, with the net effect of no increase in tension within the bolt. With conventional tools wherein the tensioning operation is carried out in a single step, it is necessary to ‘over-tension’ the bolt in order that the target tension is achieved once the bolt assembly has relaxed. For example, it may be necessary to apply a tensioning force of 110% of the target tension to the bolt, so that once the bolt assembly relaxes the net tension in the bolt is close to 100% of the target tension. Especially in assemblies which require bolts to be tensioned to very near to their material failure limits, the additional 10% of over-tension required means this may be dangerous or even not possible with the existing tools.

The inventors have identified that by breaking the target tension into smaller steps, the over-tension required, in absolute terms, is reduced. The risk to the operator is thus reduced and it is possible to safely tension bolts to tensions closer to the material failure limit of the bolt. As noted above, since it is possible to use a fluid pump developed for torque wrenches for the bolt tensioner described herein, the higher flow rates mean that the tensioning process can be carried out in approximately the same time as conventional bolt tensioners which perform a single tensioning step.

A further advantage of the present invention is that the effects of cross-talk (also known as elastic interaction) can be mitigated and reduced. In bolting applications with components joined by multiple bolts, and particularly in joints comprising gaskets, the elastic properties of the joint, and of the bolts themselves, mean that the load applied in the tightest bolts will transfer to the loosest. This can cause bolts, which had previously been at the correct tension, to relax during the tensioning of subsequent bolts and thus require re-tensioning to bring them to the correct loading. Conventionally this is mitigated by tensioning the bolts in a specific order to distribute the loading around the joint as evenly as possible, and by tensioning the first-tensioned bolts to above their final load such that they relax to the correct final tension load. However, this is not always possible e.g. when tensioning close to the material failure limit of the bolt. In such circumstances, the tensioning must be carried out in a series of ‘passes’, each progressively increasing the load until the bolts are all at the correct tension load. Such processes are slow and require many passes.

In the present invention, since the tensioning operation is carried out in multiple steps, it is possible to carry out a ‘first pass’ of the bolts to safely bring them all to close to their final tension loading. Then in a ‘second pass’, since the increase in tension within the bolts (in absolute terms) is much lower, the variation in the bolt tensions across the joint is reduced i.e. the effect of cross-talk is much lower. This results in fewer passes required to bring all of the bolts within the joint to the correct tension.

In one series of embodiments, tightening the nut may be carried out automatically by a nut drive mechanism. Optionally, the method may further comprise automatically tightening a bolt coupling connected to the bolt with a bolt coupling drive mechanism.

### BRIEF DESCRIPTION OF THE DRAWINGS

Embodiments of the invention will now be described, by way of example only, with reference to the following drawings, in which:

FIG. 1 is a perspective view of a bolt tensioner;

FIG. 2 is a cross-section through the bolt tensioner of FIG. 1 in the plane A-A;

FIG. 3 is a perspective view of the bolt tensioner of FIG. 1 in a partially dis-assembled state;

FIG. 4 is a magnified view of part of the cross section of FIG. 2;

FIG. 5 is a cross-section through the bolt tensioner of FIG. 1 in the plane B-B;

FIG. 6 is a schematic diagram showing a bolt tensioner system;

FIG. 7 is a flow diagram showing a method for tensioning a bolt;

FIG. 8 is a perspective view of a bolt tensioner;

FIG. 9 is a cross-section through the bolt tensioner of FIG. 8 in the plane C-C; and

FIG. 10 is a cross-section through the bolt tensioner of FIG. 8 in the plane D-D.

### DETAILED DESCRIPTION

The invention is illustrated in the accompanying Figures, which are meant to be exemplary and not limiting, in which like references are intended to refer to like or corresponding parts.

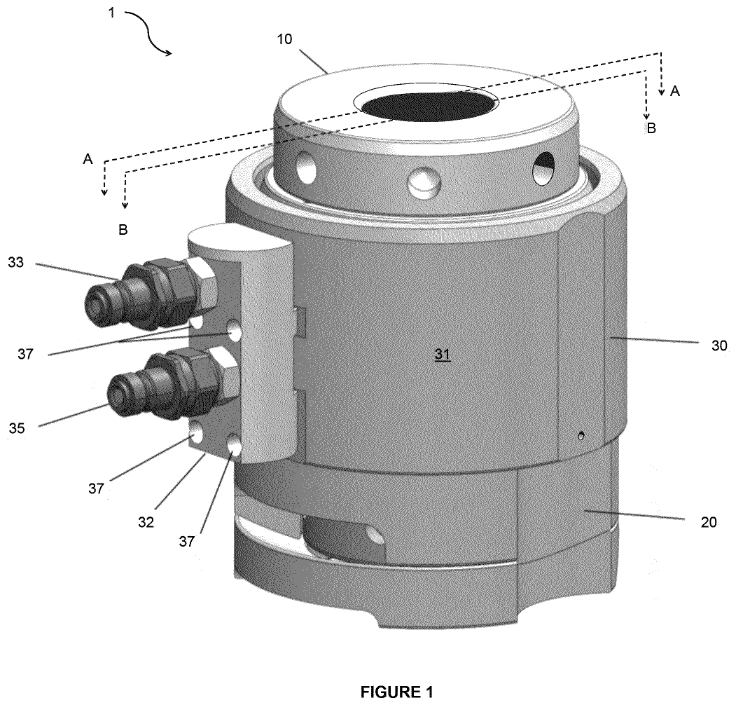

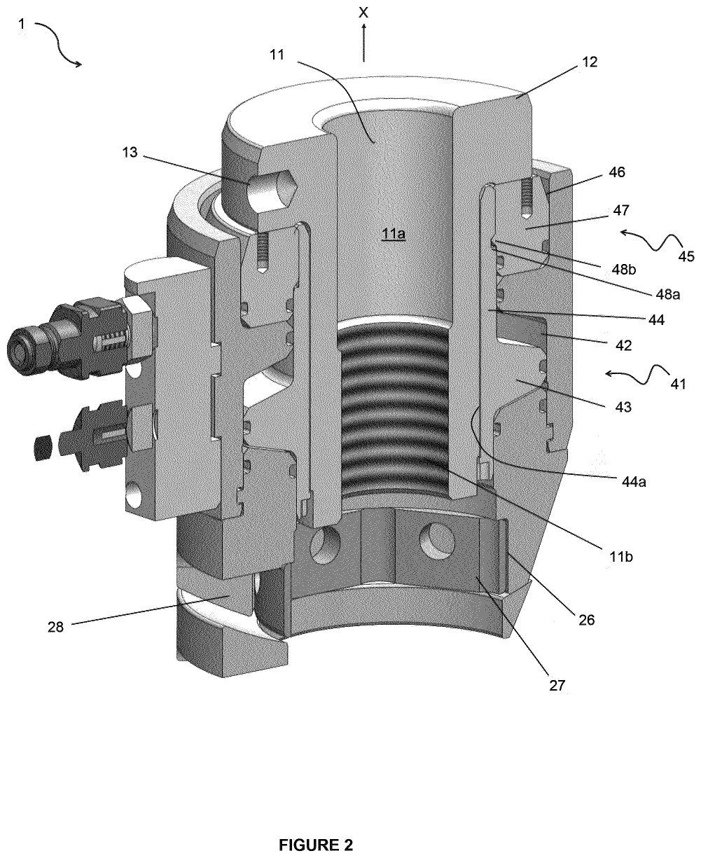

FIGS. 1 and 2 show a bolt tensioner 1. The bolt tensioner 1 has a bolt coupling 10, a bridge 20 and a load cell 30 located therebetween. In use, the bridge 20 extends over a nut and bolt to be tightened (not shown), such that the bridge 20 seats against a flat surface surrounding the nut.

The bolt coupling 10 is provided at the upper end of the load cell 30 and extends into the load cell 30. The bolt coupling 10 has a T-shaped cross-section and comprises a shaft 11 and a flange 12. The shaft 11 is tubular, and comprises a smooth-bored portion 11a and a threaded portion 11b for connecting to the thread on a bolt to be tensioned. The flange 12 extends radially and perpendicularly from the shaft 11. The flange 12 is provided with a series of apertures 13 which are arranged radially of the shaft 11, around the circumference of the flange 12. The apertures 13 extend into the flange 12 and are configured to receive a tool, such as a tommy bar or another suitable lever, in order to drive the rotation of the bolt coupling 10 and engage the internal screw thread on the threaded portion 11b with a corresponding screw thread on a bolt to be tensioned.

The load cell 30 has a cylindrical body 31 which is connected to a manifold 34. The manifold 34 has a series of fastener apertures 37 through which mechanical fasteners (not shown) extend to secure the manifold 34 to the cylindrical body 31. The manifold 34 is provided with a first fluid port 33 and a second fluid port 35 each having a hose connector for securing to a hose from a fluid pump such as a hydraulic fluid pump (not shown).

Within the load cell 30 is a first piston 41 and a second piston 45, respectively formed from a first piston chamber 42 and a first piston head 43, and a second piston chamber 46 and a second piston head 47. The first piston 41 and second piston 45 are both annular. Similarly, the first piston chamber 42 and second piston chamber 46 are both annular. The dimensions of the piston heads 43, 47 and the piston chambers 42, 46 are such that each piston head 43, 47 can move axially within its respective piston chamber 42, 46. The annular piston chambers 42, 46 and piston heads 43, 47 thus extend around the outer surface of the bolt coupling 10.

The first piston head 43 is provided with an integrally-formed piston connector 44. The piston connector 44 is a tubular shaft extending axially between the first and second piston heads 43, 47. The piston connector 44 and second piston head 47 are provided with inter-engaging formations which connect the second piston head 47 to the piston connector 44. The inter-engaging formations comprise a first screw thread 48a formed on the circumferential surface of the piston connector 44 and a corresponding screw thread 48b formed on the adjacent circumferential surface of the second piston head 47. The screw threads 48a, 48b thus lock the piston connector 44 and second piston head 47 together.

In alternative embodiments, the inter-engaging formations which connect the second piston head 47 to the piston connector 44 may have a different form. For example, the inter-engaging formations may comprise a recess in the piston connector, and a corresponding projection formed on the adjacent surface of the second piston head. The recess may be an annular groove formed around the circumference of the piston connector 44, and the projecting formation 48b may be an annular tooth that extends into the recess 48a. The recess and projecting formation may extend partially around the piston connector and the second piston head, and/or multiple recesses and projecting formations may be provided. In other alternative embodiments, the inter-engaging formations may comprise any other suitable mechanical fastening arrangement.

In further alternative embodiments, the piston connector is integrally formed with the second piston head and connected to the first piston head via said inter-engaging formations, or the piston connector is a discrete component connected to both the first and second piston heads via inter-engaging formations.

The piston connector 44 thus surrounds the outside of the bolt coupling 10, and has a smooth internal surface 44a to allow relative axial movement of the piston connector 44 and the bolt coupling 10. The upper surfaces of the second piston head 47 and the piston connector 44 form a single uniform surface which bears upon the underside of the flange 12. The use of screw threads and/or inter-engaging formations means that the piston connector 44 is easily replaceable, for example due to damage or to swap different sizes of piston connector 44 to accommodate different sizes of bolt coupling 10. The piston connector 44 ensures that the first and second pistons 41, 45 are linked and act as a single piston with an effective area equal to the combined effective area of the first piston head 43 plus the second piston head 47.

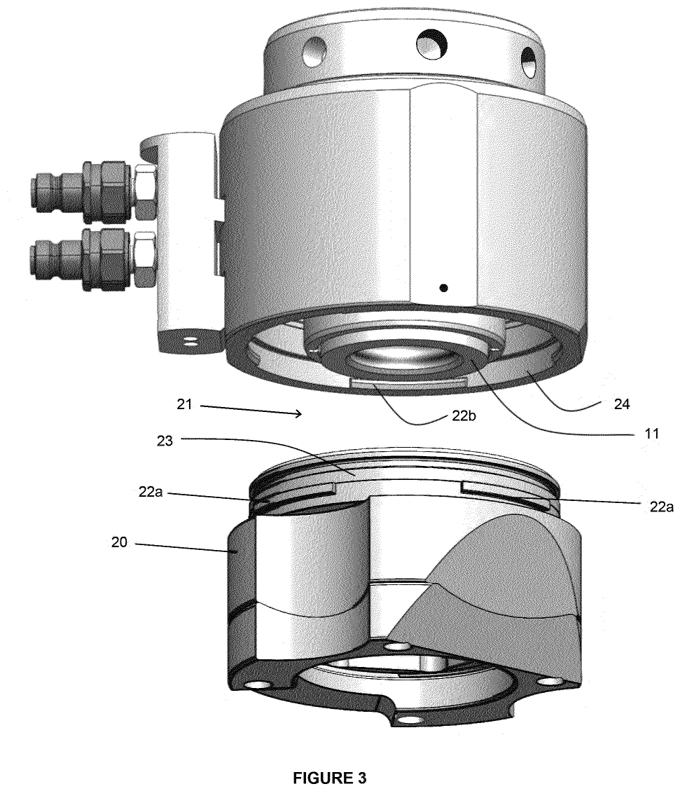

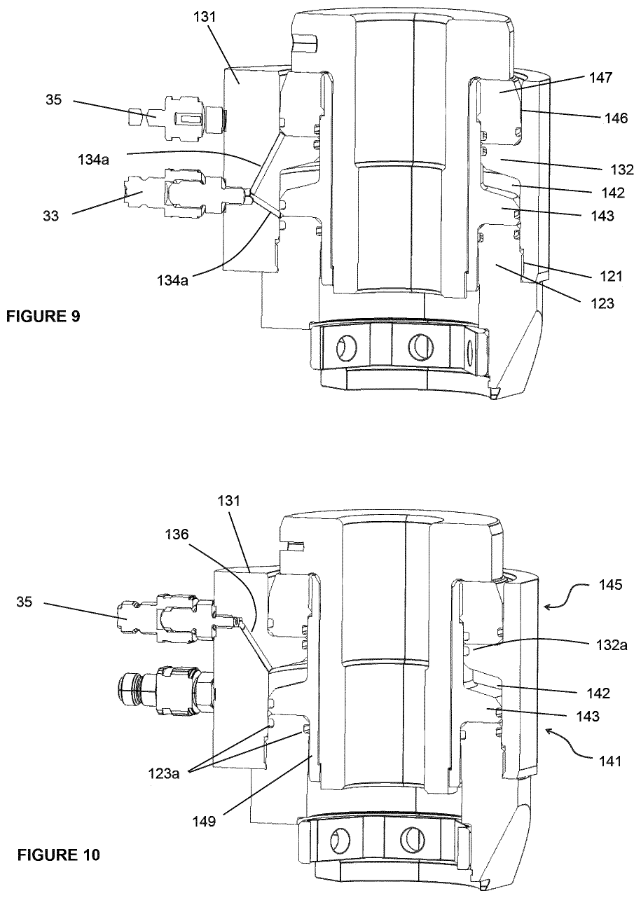

With further reference to FIG. 3, the bridge 20 is connected to the load cell 30 via a securing mechanism 21. The securing mechanism 21 is a bayonet mechanism and comprises a wall 23 which extends into a corresponding load cell opening 24 in the lower face of the load cell 20. The securing mechanism 21 has a series of bayonet arms 22a located around the wall 23 which engage corresponding bayonet arms 22b in the load cell opening 24. To connect the load cell 30 and the bridge 20, the wall 23 is inserted into the load cell opening 24, and then the bridge 20 is rotated so that the bayonet arms 22a, 22b are aligned. The securing mechanism 21 thus prevents removal of the bridge until the bridge 20 has been rotated back to its previous orientation. A further benefit of the securing mechanism 21 having the form shown in FIG. 3 is that the bayonet arms 22a, 22b provide a strong coupling between the bridge 20 and the load cell 30. In alternative embodiments, such as shown in FIGS. 9 and 10, the bayonet arms may be replaced with cooperating screw threads. Without such a strong coupling, the bridge 20 could be shorn from the load cell 30 if the pistons were to be advanced to maximum stroke and pressure builds within the piston, or when retracted without a bolt being connected to the bolt coupling 10. Thus, the securing mechanism 21 protects the bolt tensioner 1, and ensures the safety of the operator, in the event that the operator mistakenly operates the pistons at high pressures and/or without a bolt being in place.

As shown in FIG. 2, the bridge 20 has an internal cavity 26 in which is provided a nut rotation socket 27, and a tool aperture 28 through which a tool (not shown) can be inserted to engage the nut rotation socket 27 and thereby drive the rotation thereof. The tool used to drive rotation of the nut rotation socket 27 may be a manual tool (e.g., a lever, such as a tommy bar) or a power tool (e.g., an electric, pneumatic or hydraulic nut drive mechanism).

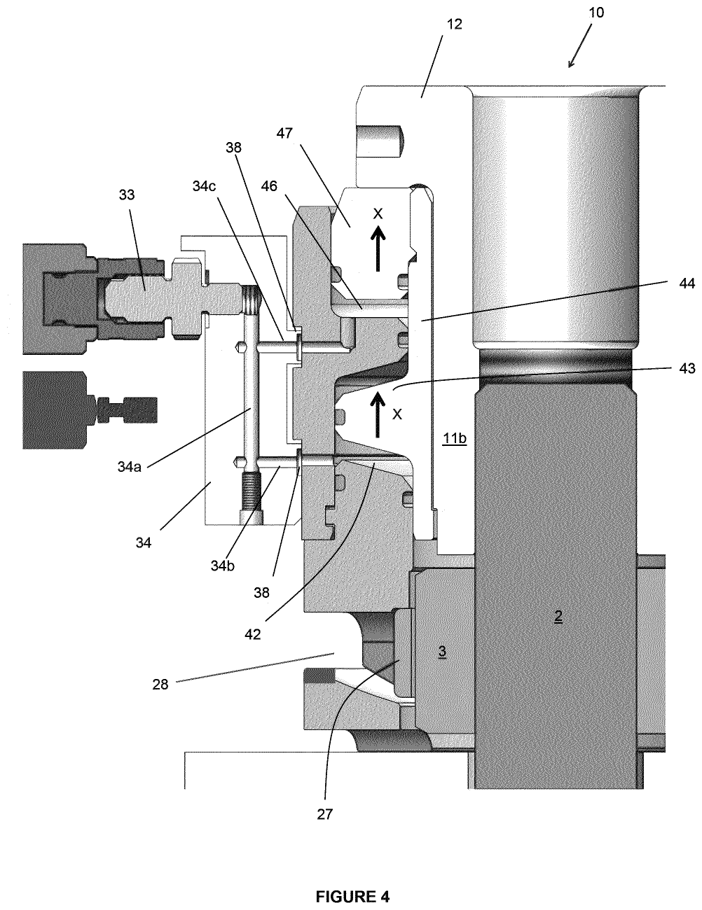

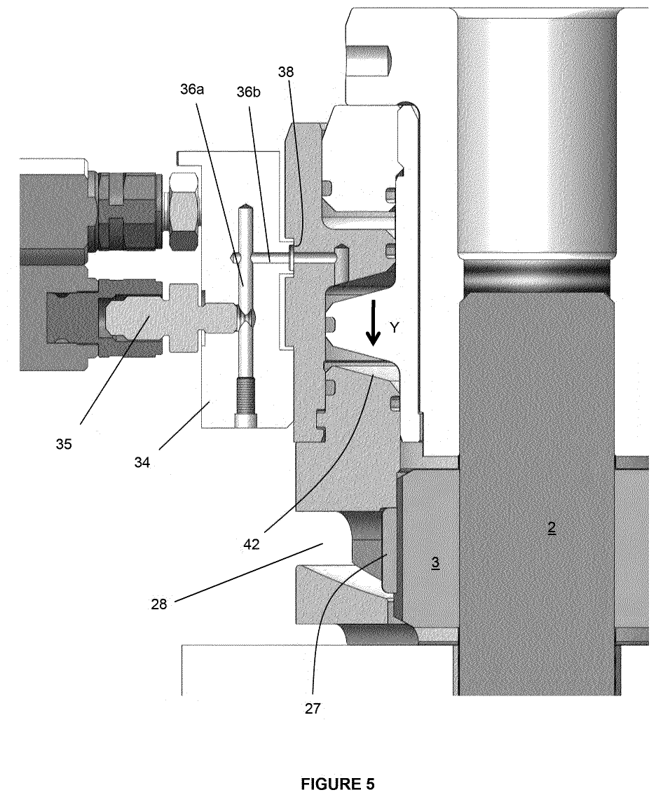

Turning now to FIGS. 4 and 5, the manifold 34 and operation of the bolt tensioner 1 will be described. In both Figures, the bolt tensioner is in an intermediate position, with the piston heads 43, 47 partially extended i.e. located half way between the fully extended and fully retracted limits.

FIG. 4 is a cross section through the plane A-A of FIG. 1, and shows the fluid path for the tensioning direction (i.e., a direction which increases the tensioning force applied to a bolt). The first fluid port 33 leads to a manifold 34 connected to the load cell 30. The manifold 34 has a first channel 34a, a first passageway 34b and a second passageway 34c. The first channel 34a extends along the manifold 34 and is fluidically connected to the first passageway 34b. The first passageway 34b connects to the first piston chamber 42. The second passageway 34c connects to the second piston chamber 46. When pressurised fluid, such as hydraulic fluid, is pumped into the first fluid port 33, the manifold 34 directs the flow to both the first and second piston 41, 45 via the first channel 34a, first passageway 34b and second passageway 34c to drive the pistons axially in the tensioning direction i.e. the direction X as shown by the arrows. The second piston head 47 bears upon the underside of the flange 12 of the bolt coupling 10, driving it upwards and thereby applying a tensioning force to the bolt 2 to which the threaded portion 11b of the bolt coupling 11 is connected. The force from the first piston head 43 is transferred via the piston connector 44 to the bolt coupling 10 via the upper surfaces of the piston connector 44 and the second piston head 47, which is connected to the piston connector 44. In some embodiments (not shown) the piston connector 44 does not bear directly upon the flange 12 and instead the force from the first piston 41 is transferred to the bolt connector 44 and on to the second piston head 47, which contacts the flange 12. In further alternative embodiments, the second piston head 47 may not contact the flange, instead transferring all force via the piston connector 44. In the embodiment shown, using the coplanar upper surfaces of both the second piston head 47 and the piston connector 44 provides a simple way of distributing the force from the pistons 41, 45 across a large area, and thus lessening any shear strain on the piston head 47 and/or the piston connector 44.

Turning now to FIG. 5, there is shown a cross-section through the bolt tensioner 1 in the plane B-B, showing the fluid path for the retraction direction.

The second fluid port 35 also leads to the manifold 34. The manifold 34 has a second channel 36a which extends along the manifold 34 and is fluidically connected to a third passageway 36b which connects to the first piston chamber 42. The third passageway 36b connects to the first piston chamber 42 on the opposite side of the first piston head 43 relative to the first passageway 34b. When pressurised fluid, such as hydraulic fluid, is pumped into the second fluid port 35, it is directed to the first piston 41 to drive it axially in the retraction direction i.e. downwards in the direction Y as shown in FIG. 5.

With additional reference to FIGS. 1 and 2, it is shown that the passageways 34b, 34c, 36b extend through the manifold 34 and the cylindrical body 31 of the load cell 30 at positions adjacent to the fastener apertures 37. Gaskets 38 are provided along the first to third passageways 34b, 34c, 36b at the location where the manifold 34 meets the cylindrical body 31. The manifold 34 is retained in position due to the mechanical fasteners (not shown), such as bolts or machine screws, which extend through the fastener apertures 37 and into the cylindrical body 31. The compressive force of the fasteners, combined with the gaskets 38, provides a suitable seal to prevent any leaks of the high pressure hydraulic fluid used within the bolt tensioner 1. The stresses caused by the high pressure fluid are thus exerted on the fasteners which hold the manifold in position, and not in the immediate structure of the first to third passageways. The first and second fluid ports 33, 35 have hose connectors which engage via screw threads with the manifold 34.

The inventors have found that this configuration allows the manifold 34 and cylindrical body 31 to be formed of different materials. In particular, this configuration ensures that the screw threaded connections i.e. between the fluid ports 33, 35 and the manifold 34, occurs in a high-strength material (such as steel), while allowing the cylindrical body 31 to be formed from a weaker material (such as aluminium or titanium). The manifold may be formed from a low carbon steel (e.g. a BS 970 steel or any comparable grade of low carbon, high tensile steel such as an ASTM A29 steel or a JIS G4103 steel) or a nickel-based alloy. The relative low density of aluminium means the overall weight of the bolt tensioner is greatly reduced compared to a bolt tensioner comprising a steel body. This configuration also ensures that the fluid ports, e.g. screw threaded hose connectors, are provided within the strongest material portion of the tool.

It will be understood that the bolt tensioner 1 described herein can be combined with any existing high pressure fluid pump. Particularly, the bolt tensioner 1 is combinable with conventional dual-output fluid pumps, such as those intended for use with torque wrenches. Pumps for torque wrenches commonly have a maximum pressure output in the region of 700 to 800 bar (70-80 MPa). The bolt tensioner 1 is combinable with such pumps, since the dual piston configuration provides a greater effective piston area than conventional single piston bolt tensioners.

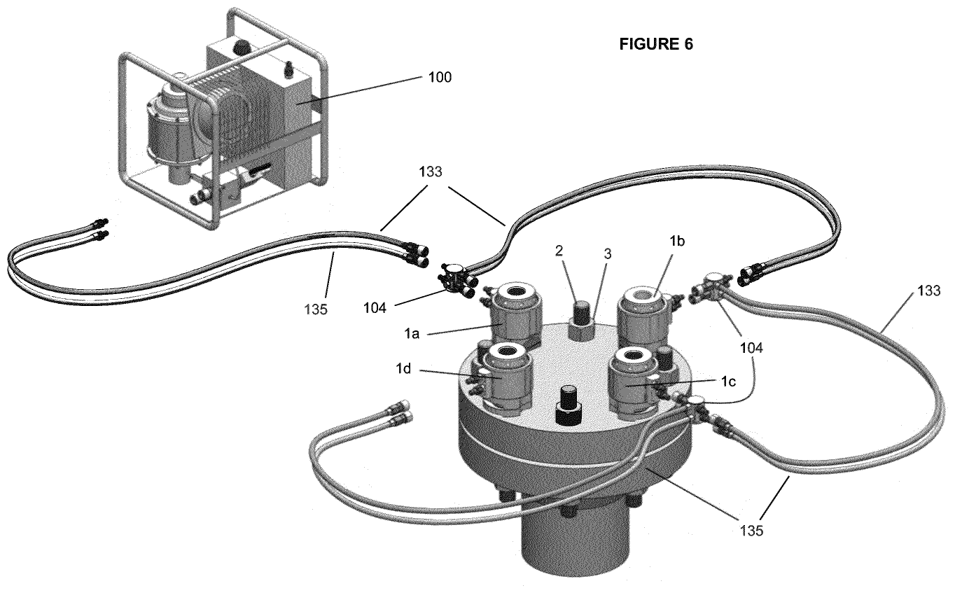

Turning now to FIG. 6, there is shown an exploded diagram of a bolt tensioner system comprising a series of bolt tensioners 1a, 1b, 1c, 1d as described above. The bolt tensioners 1a-d are all connected to a hydraulic pump 100 by a first hose 133 and a second hose 135. The first and second hoses 133, 135 are formed from multiple hose portions and connected by hose connectors 104. Each of the hose connectors 104 is configured to connect to the first and second fluid ports 33, 35 of one of the bolt tensioners 1a-d, and is provided with additional ports for connecting to another pair of hose portions. The first and second hoses 133, 135 and the hose connectors 104 thus provide a daisy chain arrangement and can provide hydraulic fluid from a single pump 100 to multiple bolt tensioners simultaneously. Thus, multiple bolts 2 can be tensioned simultaneously and thus speed up a tensioning process in situ.

The method of operation of the bolt tensioner 1 will now be described.

In use, the bolt tensioner 1 is located over a nut 3 and bolt 2 assembly, such that the bolt 2 extends into the load cell 30 and the nut 3 is received within a nut rotation socket (NRS) 27 within the bridge 20. The threaded portion 11b of the bolt coupling 10 is threaded onto the bolt 2 until it rests against the second piston 45. A dual-output fluid pump is provided, and the pump's two output hoses are connected to the first and second fluid ports 33, 35 respectively. The bolt tensioner 1 is then ready for operation.

The operator initiates a tensioning operation by supplying pressurised fluid to the first fluid port 35 in order to pressurise the pistons 41, 45. The pistons 41, 45 rise, lifting the bolt coupling 10, and increasing the tension in the bolt 2 until the desired tension is achieved. The operator then tightens the nut 3, either manually by inserting a lever into the NRS 27 and applying a force thereto to rotate the NRS 27 and nut 3, or by operating an automatic nut drive mechanism. The operator then supplies pressurised fluid to the second fluid port 35 until the pistons 41, 45 are fully retracted. The bolt tensioner 1 can then be demounted from the bolt 2, and repositioned on a further bolt for a subsequent tensioning operation as needed.

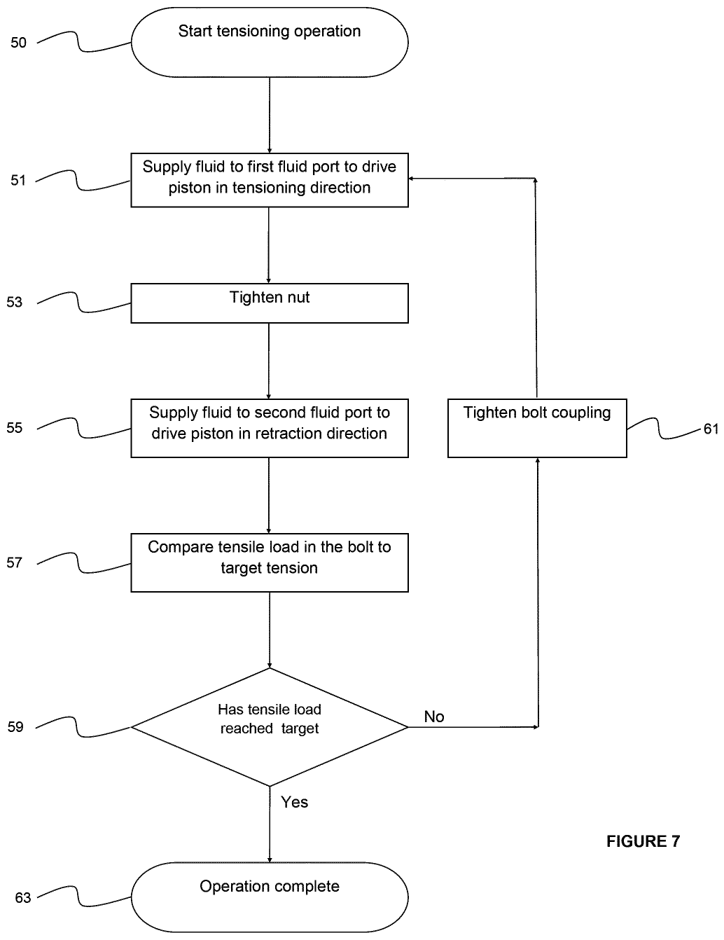

An alternative method of operation of the bolt tensioner 1 will now be described with reference to FIG. 7 and with additional reference to FIGS. 4 and 5. The bolt tensioner is mounted on a bolt as described above. The operator initiates a tensioning operation 50 by supplying pressurised fluid to the first fluid port in order to pressurise the pistons 51. The first piston 41 (and optionally second piston 45) rises, lifting the bolt coupling 10 and partially tensioning the bolt 2.

The operator then tightens the nut 53, either manually by inserting a lever into the NRS 27 and applying a force thereto to rotate the NRS 27 and nut 3, or by operating an automatic nut drive mechanism. Since the bolt 2 has been incompletely tensioned, the nut 3 will tighten only a small amount before further rotation is no longer possible.

The operator then releases the pressure from the first fluid output feed, and supplies fluid from the second pump output to the second fluid port 55. The first piston 41 is thus driven downwards, i.e. in the retraction direction Y. In embodiments with two pistons, since the pistons 41, 45 are connected by the piston connector 44, both pistons 41, 45 are retracted simultaneously. Since the resistance against the pistons 41, 45 is lower in the retraction direction, and since only the first piston chamber 42 is supplied with fluid from the second fluid port 35, the retraction occurs at a faster rate than the tensioning movement. With the pistons 41, 45 no longer applying a force to the bolt 2, the bolt 2 is able to elastically relax. Because the nut 3 has been partially tightened in the previous step, the bolt 2 cannot relax back to its original position and tension and thus, the net effect is an increase in tension within the bolt.

The tensile load within the bolt is then compared to the target tension 57. The tensile load within the bolt is equal to the force applied thereto by the pistons, minus any loss due to the bolt relaxing once the tensioning force has been removed. As the tensile load within the bolt increases, the fluid pressure being provided by the pump increases too. Since the relaxation is predictable, the tensile load in the bolt can easily be calculated from the final fluid pressure during the tensioning step. The pump, the bolt tensioner 1, or a controller can thus calculate the current tension within the bolt automatically, or display the tensile load on a display for the operator to view.

A check is performed to see if the tensile load in the bolt has reached the target tension 59. This can be carried out by the operator or automatically by a controller.

If the tensile loading in the bolt is below the target tension, the bolt coupling is tightened 61, either manually by inserting a lever into the bolt coupling and applying a force thereto, or by operating an automatic bolt coupling drive mechanism. Since the increase in tension was a relatively small step, the bolt coupling will tighten only a small amount before the flange 12 contacts the piston and further rotation is no longer possible.

The process as described above is then repeated until the tensile loading within the bolt reaches the target tension and the operation is complete 63. The bolt tensioner 1 can be removed from the bolt.

In further methods, the pump can be configured to cycle back and forth between the first and second fluid outputs, and thus the bolt tensioner 1 cycles repeatedly between tension and retraction. The operator can thus apply a relatively continuous force on the nut, which will thus tighten when the bolt is being tensioned and will not rotate when the pistons 41, 45 are being retracted and a tensioning force is not being applied to the bolt. Similarly, the operator can apply a relatively continuous force on the bolt coupling 10 to progressively tighten the bolt coupling 10 onto the bolt once the bolt has relaxed. As above, the tightening process for the nut and bolt coupling 10 can be simplified with automatic drive mechanisms.

It will be appreciated that the number of tensioning operations required to reach the target tension depends on the requirements of the assembly and the operator's preference. The operator may wish to carry out two equal tensioning steps, whereby the tension in the bolt is increased by 50% of the target tension in each step. Alternatively, the target tension could be achieved through a series of equal steps, e.g. 3, 4, 5, 10 or more discrete steps.

Equally, the method may be carried such that the tensioning operations are unequal. The method may use larger initial steps, and smaller later steps. This can be advantageous, since the bulk of the tension could be imparted quickly, and then the bolt tension be raised to the target tension in smaller steps which requires smaller overloading in absolute terms. In further methods, the initial tensioning steps may primarily relate to removing the compliance in the joint e.g. where the bolts connect two flanged components, there may be some initial settling between the two flange surfaces.

The initial tensioning steps may thus only increase the bolt tension by a small amount while the joint compliance is being taken up. In such circumstances, a graph of bolt tension over time would curve upwards as the tension increases slowly at first and more rapidly later. Similarly, if this were combined with smaller tension steps when approaching the target tension, the graph would have an S-shape profile as the tension is increased more slowly at the start and end of the process. Ultimately, the method can be modified to fit the operator's requirements and engineering requirements.

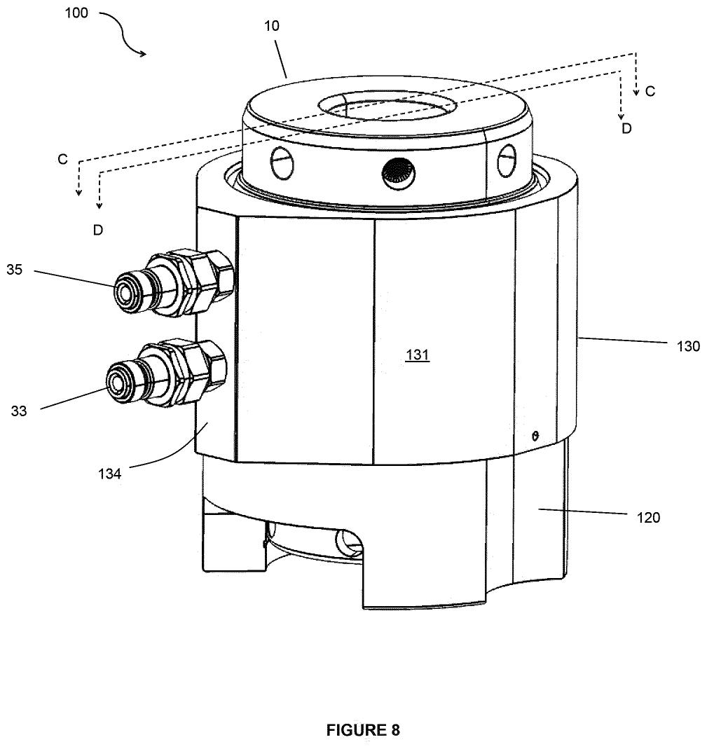

FIGS. 8 to 10 show a bolt tensioner 100. The bolt tensioner 100 shares many components and features with the bolt tensioner 1 and descriptions for shared features are as described above. The bolt tensioner 1 has a bolt coupling 10, a bridge 120 and a load cell 130 located therebetween. In use, the bridge 120 extends over a nut and bolt to be tightened (not shown), such that the bridge 120 seats against a flat surface surrounding the nut. The bridge 120 is connected to the load cell 130 via a securing mechanism 121. The securing mechanism 121 comprises a wall 123 which extends into a corresponding load cell opening in the lower face of the load cell 130. The securing mechanism 121 differs from that shown in FIG. 3, in that the wall 123 has a screw threaded surface which engages a cooperating screw threaded surface on the lower internal wall of the body 131. It is understood that either securing mechanism 21, 121 can be used with any of the embodiments described herein.

The wall 123 is provided with a pair of annular recesses 123a on each side thereof for locating ring seals (not shown) therein for sealing the wall with the body 131 and a tail portion 149 of the first piston 141. The tail portion 149 extends past the adjacent annular recess 123a and ring seal such that the seal is maintained throughout movement of the first piston 141. The upper surface of the wall 123 forms the lower surface of the first piston chamber 142, reducing the overall height of the first piston 141.

As shown in FIGS. 9 and 10, and similarly with the embodiment of FIGS. 1 to 5, the wall 123, 23 is integrally formed with the upper end of the bridge. In alternative embodiments (not shown), the wall 123, 23 may be a separate component. The separate wall would be connectable to the body 131 in the same manner as shown, and may be attachable to the bridge e.g. by mechanical fasteners or simply by a recess for seating onto the bridge or vice versa.

As shown in FIGS. 9 and 10, the body 131 extends around the first and second piston heads 143, 147 and has first and second piston chambers 142, 146. By providing both piston chambers within the body 31, the number of components is minimised and production costs are reduced accordingly. As also shown, but not described, in FIGS. 2, 4 and 5, the internal surface of the body 131 is provided with a shoulder 132. The shoulder 132 separates the first and second piston chambers 142, 146, and is integrally formed in the body 131. In alternative embodiments (not shown) the shoulder 132 is connected to the body 131 via mechanical fasteners. The shoulder 132 thus forms the upper surface of the first piston chamber 142, and the lower surface of the second piston chamber 146, and has an annular recess 132a for securing a ring seal therein (not shown). The shoulder 132 forms a physical stop or barrier, preventing overextension of the pistons by limiting the range of movement of the first piston head 143. Since the second piston head 147 is connected to the first piston head 143, the second piston head 147 is stopped from overextending beyond the edge of the second piston chamber 146. Since the bolt tensioner 1, 100 is operated at lower hydraulic pressures (e.g. 700 bar), and since the pressure forces applied on the shoulder 132 are balanced from each of the first and second pistons 41, 45, 141, 145, the shoulder 132 can retain the pistons without concern of material failure or requiring a pressure release valve. The shoulder 132 thus acts as a safety device preventing damage to the tool or the bolt.

The load cell 130 has a teardrop-shaped body 131 which has an integrally formed manifold region 134 located at the tip of the teardrop. The manifold 134 is provided with a first fluid port 33 and a second fluid port 35 each having a hose connector as described previously. FIG. 9 shows the fluid path for the tensioning direction. The first fluid port 33 leads to a first and second passageway 134a, 134b which connect to the first and second piston chamber 142, 146 respectively.

As shown in FIG. 10, the second fluid port 35 leads to a third passageway 136 which connects to the first piston chamber 142. The third passageway 136 connects to the first piston chamber 142 on the opposite side of the first piston head 143 relative to the first passageway 134a. When pressurised fluid, such as hydraulic fluid, is pumped into the second fluid port 35, it is directed to the first piston 141 to drive it axially in the retraction direction.

With respect to both bolt tensioner 1 and bolt tensioner 100, by providing a manifold 34, 134 which connects a second fluid port 35 to the first piston 41, 141, and by connecting the first and second pistons 41, 141, 45, 145, retraction of the pistons is achievable without requiring a force be applied on the uppermost of the pistons. In known prior art bolt tensioners, springs or pneumatics are typically used to bias the uppermost piston in the retraction direction (i.e. downwards). This requires the retraction mechanism to be located above the uppermost piston, and significantly increases the height of the bolt tensioner. The present invention thus benefits from automatic retraction of the pistons and has a significantly reduced height. Reductions in height are desirable since they lead to a reduced weight and lower production costs, and make the tool easier to manoeuvre and position for the operators.

1. A bolt tensioner comprising:
a load cell comprising at least one piston and a piston retraction mechanism; wherein
the bolt tensioner comprises a first fluid port in fluid communication with the at least one piston for receiving a pressurised fluid to apply a tensioning force thereto; and wherein
the piston retraction mechanism comprises a second fluid port operatively connected to the at least one piston for receiving a pressurised fluid to apply a return force thereto, said return force being opposite to the tensioning force.

2. The bolt tensioner according to claim 1, wherein the at least one piston comprises a piston head located within a piston chamber in the load cell; and
further comprising a manifold configured to direct fluid from the first fluid port to the piston chamber on a first side of the piston head; and wherein
the piston retraction mechanism is configured to direct fluid from the second fluid port to the piston chamber on the opposite side of the piston head.

3. The bolt tensioner according to claim 2, wherein the at least one piston comprises a first piston and a second piston; wherein
the manifold is configured to connect the first fluid port to the first and second piston.

4. The bolt tensioner according to claim 3, wherein the load cell comprises a first and second piston chamber for the first and second pistons respectively, and wherein the load cell comprises a shoulder located between the first and second piston chambers.

5. The bolt tensioner according to claim 2, wherein the load cell comprises a body, and wherein the manifold is integrally formed in the body.

6. The bolt tensioner according to claim 2, wherein load cell comprises a body formed of a first material, and
the manifold is formed of a second material, and connected to the body by one or more mechanical fasteners.

7. The bolt tensioner according to claim 6, wherein the first material comprises a lightweight metal or alloy.

8. The bolt tensioner according to claim 6, wherein the second material comprises a material stronger than the first material.

9. The bolt tensioner according to claim 3, comprising a piston connector connecting the first and second pistons, the piston connector comprising a screw thread and/or interlocking formation for engaging a corresponding screw thread and/or interlocking formation on the first and/or second pistons.

10. The bolt tensioner according to claim 3, wherein the piston retraction mechanism is configured to direct fluid from the second fluid port to only one of the first and second pistons.

11. The bolt tensioner according to claim 1, wherein the piston retraction mechanism is hydraulically driven.

12. The bolt tensioner according to claim 1, wherein the at least one piston has a stroke length of less than 12 mm.

13. The bolt tensioner according to claim 1, further comprising a bridge configured to extend over and/or around a nut and bolt to be tensioned and seat against the surface in which said nut and bolt are located.

14. The bolt tensioner according to claim 13, wherein the bridge is connectable to the load cell and configured such that it forms a surface of the at least one piston.

15. The bolt tensioner according to claim 1, further comprising a nut drive mechanism configured to provide a torque to a nut in use.

16. The bolt tensioner according to claim 1, further comprising:
a bolt coupling for engaging a bolt to be tensioned; and
a bolt coupling drive mechanism configured to apply a torque to the bolt coupling in use.

17. A bolt tensioner system for tensioning a bolt, the system comprising:
one or more bolt tensioners according to claim 1; and
one or more fluid pumps comprising at least two output feeds.

18. The bolt tensioner system according to claim 17, wherein the fluid pump is configured to automatically cycle between each output feed.

19. The bolt tensioner system according to claim 17, wherein the fluid pump has a maximum output pressure of 800 bar.

20. A method for tensioning a bolt, the method comprising:
engaging a nut with a bolt;
connecting a bolt tensioner according to claim 1 to the bolt;
performing a tensioning operation comprising: operating the bolt tensioner to increase the tension in the bolt by less than a target tension, tightening the nut, and retracting the piston; and
repeating the tensioning operation until the target tension is achieved.

21. The method according to claim 20, wherein tightening the nut is carried out automatically by a nut drive mechanism.

22. The method according to claim 20, further comprising automatically tightening a bolt coupling with a bolt coupling drive mechanism.
